(19) United States
(12) Patent Application Publication
(10) Pub. No.: US 2014/0008344 A1
(43) Pub. Date: Jan. 9, 2014

(54) MULTI-WIRE WELDING CONSUMABLE

(71) Applicant: LINCOLN GLOBAL, INC., City of Industry, CA (US)

(72) Inventor: Edward ENYEDY, Eastlake, OH (US)

(73) Assignee: LINCOLN GLOBAL, INC., City of Industry, CA (US)

(21) Appl. No.: 13/787,972

(22) Filed: Mar. 7, 2013

Related U.S. Application Data
(60) Provisional application No. 61/668,822, filed on Jul. 6, 2012.

(51) Int. Cl. B23K 35/02

(52) U.S. Cl. CPC B23K 35/0261
USPC 219/145.1

(57) ABSTRACT

A consumable for use in any of brazing, cladding, building up, filling, hard-facing overlaying, welding, and joining applications is provided. In some embodiments, the consumable includes a first consumable portion having an outer surface and a second consumable portion having an outer surface. The outer surface of the first consumable portion is secured to the outer surface of the second consumable portion to form a hot-wire consumable. The maximum distance from said outer surface of the first consumable portion to the outer surface of said second consumable portion defines a diameter of a circumscribing circle around the hot-wire consumable. The diameter of the circumscribing circle is in a range from 0.030 inch to 0.250 inch.

### PRIORITY

The present application claims priority to U.S. Provisional Patent Application No. 61/668,822. which is incorporated herein by reference in its entirety.

### TECHNICAL FIELD

This invention relates to welding consumable. More specifically, the subject invention relates to a consumable made up of a plurality of smaller consumables in a braided configuration.

### BACKGROUND

Shown in FIG. 1 is an exemplary system 100 for carrying out a hot wire process. A consumable or filler wire is fed through a contact tube 160 which applies a heating signal voltage and/or current from a hot wire power supply 170 to heat the consumable wire to its melting or near its melting point. The consumable is brought into proximity and spaced from a workpiece 115. At a consumable tip-to-workpiece distance, an arc tends to form between the consumable wire and the workpiece. Unless controlled, the arc generation may be undesirable because it may generate a spatter. Additional details of the system 100 are shown and described in U.S. Patent Publication No. 2011/0297658 and U.S. Patent Publication No. 2010/0176109, each of which is incorporated by reference in their entireties.

Known welding consumables can have varying configurations including a solid filler wire, flux-coated and flux cored filler wires. Exemplary embodiments of known filler wires and welding processes are shown and described in The Lincoln Electric Company publications: (i) Publication No. 06.4000, entitled “Welding Guide: Stainless Steels” (February 2011); and (ii) Murex Product Catalog ADCM23C (March 2005).

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention provide for a consumable for use in a joining process and more particularly in a hot wire process. The present invention can also be used in other processes such as brazing, cladding, building up, filling, hard-facing overlaying, and welding. In one embodiment a consumable wire includes a plurality of wires bound together to define a circumscribing circle ranging from about 0.030 inch to about ¼ inch. In another embodiment, a consumable wire includes a plurality of wire portions that are formed as an integral component. In some embodiments, the cross-sectional area of the plurality of wires or wire portions is less than a cross-sectional area of the circumscribing circle. The wire, when coupled to a heating current/signal, heats to a level at or near its melting temperature to allow it to be fully melted or consumed in a molten puddle. However, because of the novel configuration of the consumable, no arc is generated, even at very high heating current levels. In some hot-wire applications using a solid or traditionally constructed consumable the high heating currents can lead to arcing, which can be disadvantageous. In one aspect, one of the plurality of wires is wrapped about the other of the plurality of wires. More particularly, the wrapped wire is helically wrapped about the other of the wires. In an alternate embodiment, one of the plurality of wires is a central core and more particularly is magnetized.

In some embodiments, the consumable includes a first consumable portion having an outer surface and a second consumable portion having an outer surface. The outer surface of the first consumable portion is secured to the outer surface of the second consumable portion to form a hot-wire consumable. The maximum distance from said outer surface of the first consumable portion to the outer surface of said second consumable portion defines a diameter of a circumscribing circle around the hot-wire consumable. The diameter of the circumscribing circle is in a range from 0.030 inch to 0.250 inch.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is an illustrative schematic of a hot wire system;

FIGS. 2A-2B is an illustrative embodiment of a consumable wire for use in the system of FIG. 1;

FIGS. 2C-2D are alternate configurations of the consumable wire of FIGS. 2A-2B;

FIGS. 3A-3C are various configurations of another embodiment of a consumable wire for use in the system of FIG. 1;

FIG. 4 is another embodiment of a consumable wire for use in the system of FIG. 1.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

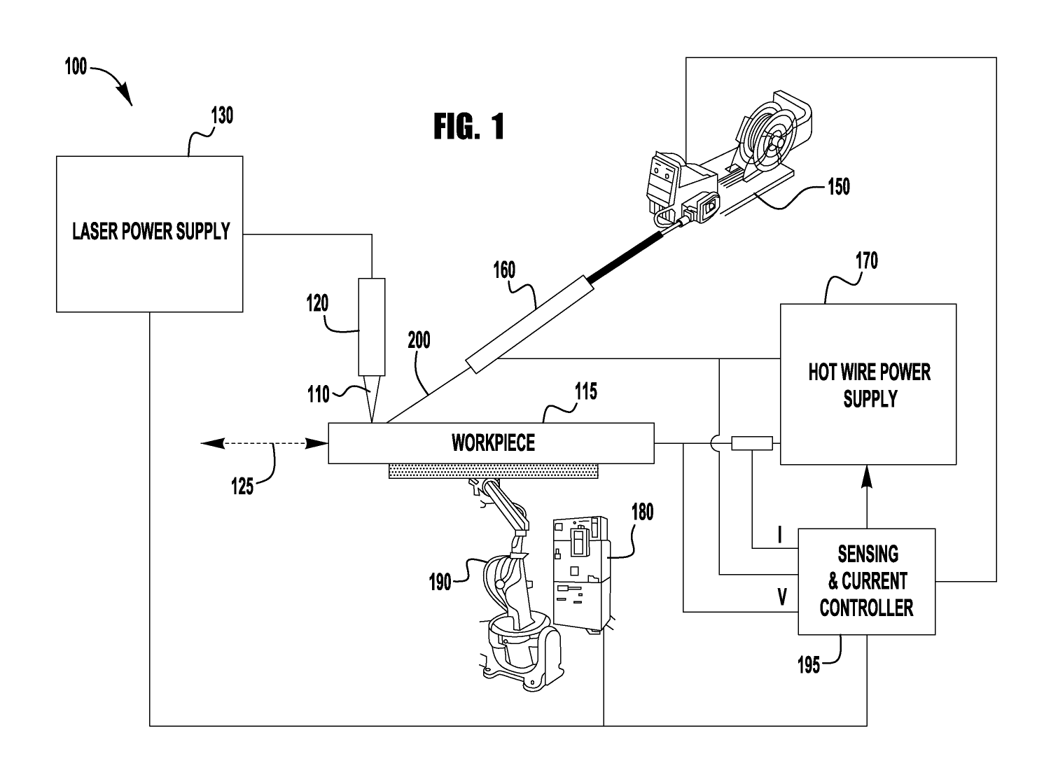

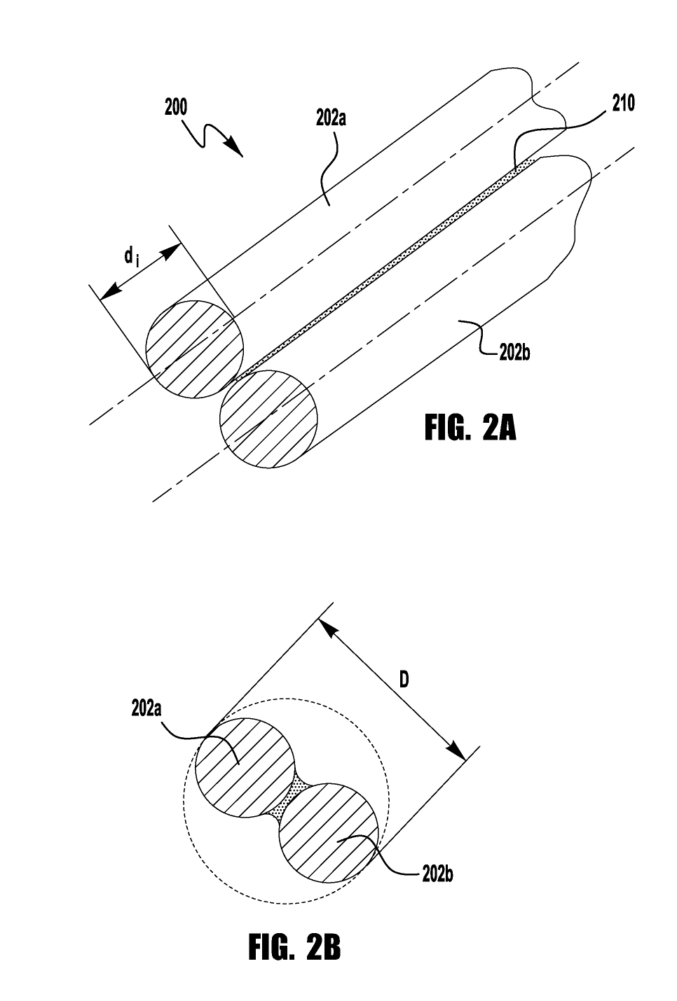

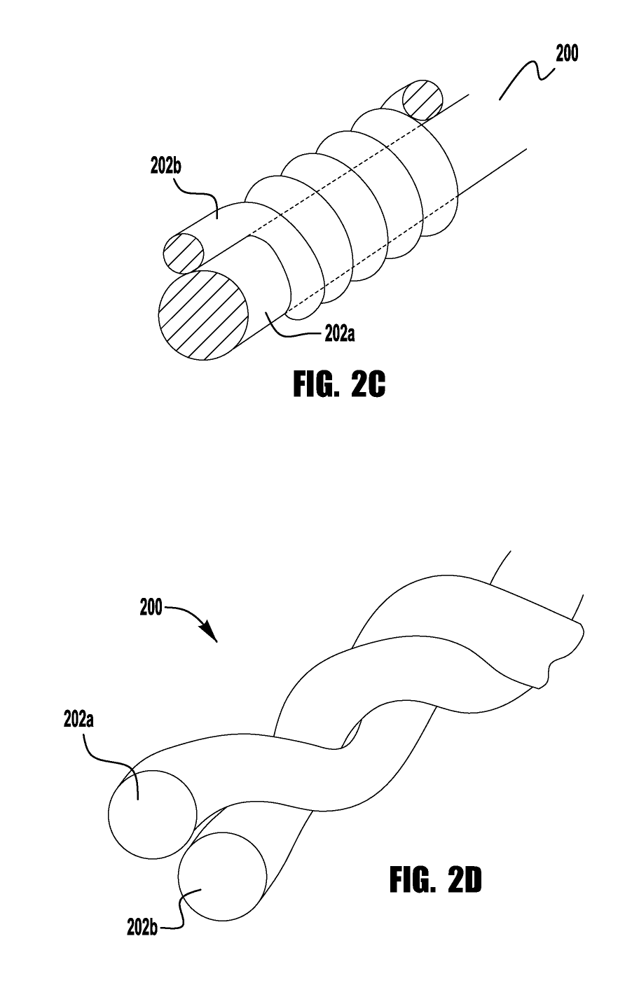

An exemplary embodiment of the invention provides a filler wire consumable 200 for use in a hot wire process and system such as for example, the system 100 of FIG. 1. The consumable is generally configured to prevent formation of an arc between the consumable wire 200 and a workpiece 115. That is, exemplary embodiments of the present invention are comprised of a plurality of smaller diameter or sized components to make up a larger single composite wire 200. Because of the smaller sub-components it is more difficult for the wire 200 to create and/or sustain an arc and thus embodiments can perform optimally in a hot-wire process where the formation of an arc is undesirable. In an exemplary embodiment (see FIGS. 2A and 2B), the consumable wire 200 includes two or more wires 202a/202b bundled together to define an overall cross-sectional area of the consumable 200 having a cross-sectional area that is less than a circular shape having the same maximum outside diameter D of the wire 200. That is, the total cross-sectional area of the wires 202a/202b and any bonding 210 having a maximum outer width or dimension D is less than that of a circular shape having the dimension D as its diameter. In exemplary embodiments of the present invention, the consumable wire 200 is suitably sized for feeding through contact tubes, wire feeders, welding torches, etc. that use known filler wires ranging in nominal sizes from 0.030 inch to about ¼ inch diameter for typical hot wire, GMAW or GTAW welding operations. That is, the dimension D allows the wire 200 to be used with known wire feeding and hot-wire devices. Of course, other maximum dimensions can be used, as needed.

As shown in each of FIGS. 2A and 2B the wires 202a and 202b can be bonded to each other via a bonding 210. The bond 210 can be via any means, such as adhesive or can be mechanical such as soldering or brazing. However, the bonding 210 method should utilize materials which would be compatible with or desirable to be deposited into the molten puddle being created during the hot wire process. In some exemplary embodiments, the wire 200 can be made as a single integral unit having portions 202a and 202b connected via an integral bonding of the same material. Further, in some exemplary embodiments, the bonding 210 can be an adhesive or bonding that is not compatible with the molten weld puddle, but in such embodiments the bonding 210 should be of a type that vaporizes with the heating of the wire 200 during the hot-wire process. In such embodiments, the bonding 210 would not be deposited into the puddle but will be removed from the wire 200 via vaporization and fume extraction prior to the wire 200 making contact with a puddle.

In some exemplary embodiments of the invention, each of the wires 202a and 202b have the same composition and properties, including physical dimensions. However, this is not always the case. For example, in some exemplary embodiments, the cross-sectional area of each of the portions 202a and 202b are different such that one is larger than the other. Additionally and alternatively, the wires 202a and 202b can have different shapes as desired. Furthermore, the wires may be of different composition. That is, one of the wires 202a/202b can be of a composition that is primarily utilized for the joining of two workpieces while the other 202a/202b is of a composition that is primarily utilized for providing corrosion resistance for a resultant weld bead. In some exemplary embodiments, at least one of the wires 202a/202b has a composition similar to that of known GMAW or GTAW welding consumables, such as ER70S-3/-6 type consumables.

Further, embodiments of the present invention are not limited as to their packaging or delivery methods, such that consumables of the present invention can be packaged in either spools, reels, boxes, drums or can be formed as stick electrodes.

As stated above, shown in FIGS. 2A and 2B is an exemplary embodiment of a consumable 200. The consumable 200 includes a first wire 202a bound to a second wire 202b having diameters dᵢ. The diameters of the wires 202a, 202b may be equal or alternatively may be different. In one particular aspect, the cross-sectional area of the consumable 200 defines a circumscribing circle having a diameter ranging from a minimum of about 0.030 inch to a maximum of about ¼ inch. Accordingly, the subject consumable 200 in one aspect is suitably sized for feeding through contact tubes or welding torches that use known filler wire ranging in nominal sizes from 0.030 inch to about ¼ inch diameter for typical hot wire, GMAW or GMAW welding operations. The consumable wires 202a, 202b may be bound together so as to extend parallel to one another over the length of the consumable 200. This is similar to what is shown in FIG. 2A, where the wires 202a/202b are shown to be generally straight. In an alternate embodiment, the second wire 200b can be wound about the first wire 200a. That is, at least one of the wires 202a/202b can be wound such as to have a helical or braided appearance. In such embodiments, it may not be necessary to use a bonding 210 as the helical/braided wire will be mechanically held in place. FIG. 2C shows one embodiment where the first wire 202b is coiled about the second wire 202a, which is oriented relatively straight with respect to the coiled wire 202b. The coiled wire 202b is coiled at a frequency (revolutions per inch) which provides sufficient deposition for the consumable 200. In another embodiment, as shown in FIG. 2D, each of the wires 202a/202b are braided or helically wrapped with each other, where each of the wires have a helical shape and are secured to each other via the helical wrapping. Of course bonding can also be used to further secure the wraps to each other.

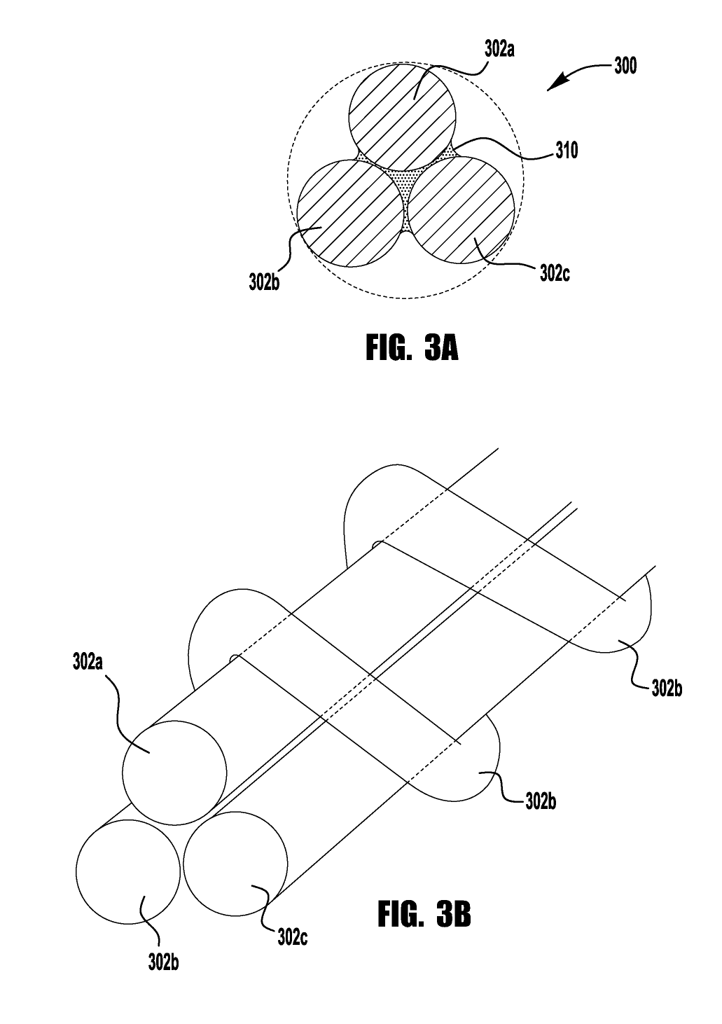

In a second embodiment shown in FIG. 3A, a consumable 300 has more than two wires. In an exemplary embodiment, the consumable 300 is formed with three consumable wires 302a, 302b, 302c. The wires can be joined together via similar methods and construction as described above with respect to the consumable 200 of FIGS. 2A-2D. For example, two wires 302a, 302b may extend linearly parallel to one another and the third wire 302c may be coiled about the two joined wires 302a, 302b as seen for example in FIG. 3B. A cross-sectional view of the consumable 300 is shown in FIG. 3A. In another aspect, the cross-sectional area defines a circumscribing circle having a diameter ranging from a minimum of about 0.030 inch to a maximum of about ¼ inch. Again, the diameter can be any desired diameter, but in exemplary embodiments the maximum diameter of the wire 300 is similar to that of solid/cored consumables of a standard construction. Again, bonding 310 can be utilized to aid in holding the wires 302a, 302b and 302c together (see FIG. 3A), or the consumable 300 can be made as a single integral component that has portions 302a, 302b and 302c made as shown which are integrally secured to each other. Of course, the consumable 300 can also be formed by helically twisting all of the wires 302a, 302b and 302c, as generally depicted in FIG. 2D. Shown in FIG. 3C is an alternate arrangement of the consumable 300′ having five combined wires 302d, 302e, 302f, 302g, 302h of variable diameters. For example, each of the wires 302e-h can have the same diameter and the wire 302d can have either a smaller or larger diameter. Additionally, the wires 302d-h can have varying compositions to provide the overall desired weld joint composition. Again, the wires 302d-h can be secured to each other via various means including bonding, helical wrapping or being made integral to each other.

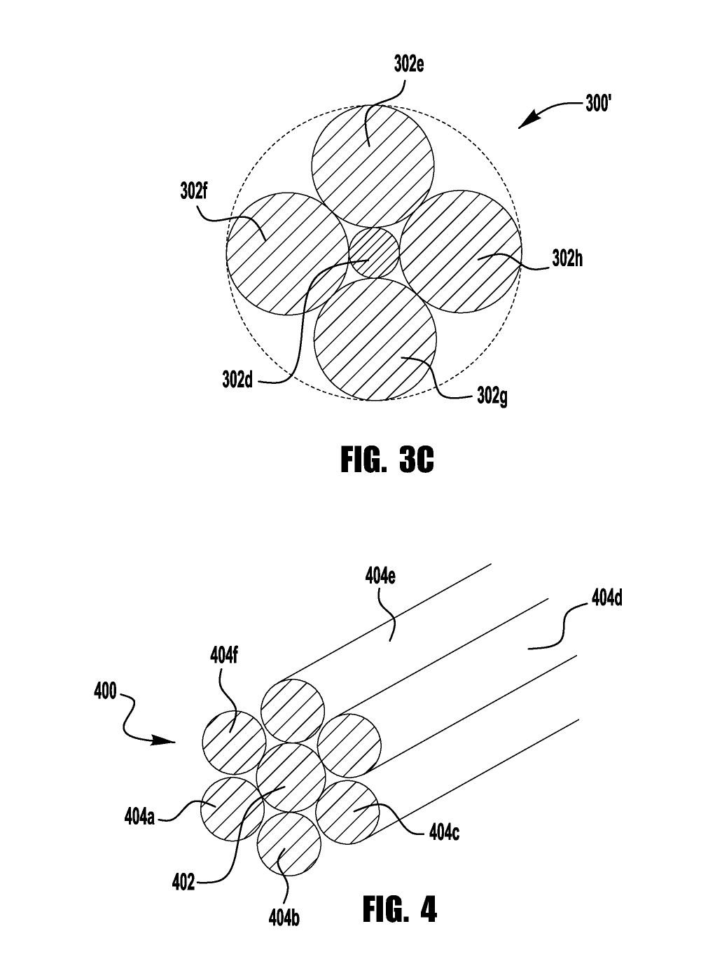

An additional embodiment of a consumable 400 is shown in FIG. 4A in which a plurality of wires are arranged and bound together about a core element 402. In an exemplary embodiment of the present invention, the core 402 is a magnetized element formed from a magnetic material, such as mild steel. Surrounding the core 402 are at least one, and in some embodiments a plurality of wires 404a, 404b, 404c, 404d, 404e, 404f, 404g, 404h. The wires may be bound about the core 402 using any one or more of the techniques described above.

As shown above, embodiments of the present invention use a braided consumable made up of a plurality of wires because such a construction aids in preventing arc formation during hot-wire welding/cladding operations. During some methods of hot-wire welding the consumable is heated to at or near its melting temperature using a heating current provided from a power supply. For example, some methods use resistance heating to heat the consumable where a current is passed through the consumable and into the work piece. To ensure sufficient heating the current levels used can be very high, and can be very near or at arc generation levels and when using a traditionally constructed consumable (having a solid or cored construction) the current levels can tend to create arcing events which can be detrimental to the welding/cladding process. The construction of embodiments of the present invention aid in preventing arc creation because the smaller diameter wires which are used to make up the consumable assembly (see, e.g., 200 and 300) are less susceptible to sustaining an arc. Thus, the construction of embodiments of the present invention aid in preventing the creation of an arc because of the smaller diameters being utilized. By aiding in the prevention of arc creation, embodiments of the present invention can make hot-wire welding/cladding more stable, and is thus advantageous.

The use of the magnetized core 402, as described above, aids in interfering with the transfer of a heating current between the wires 404a-f. Because these wires are conductive and can be in conductive contact with each other, the heating current can be accumulated in the wires 404a-f and increasing the chances of creating arc. The presence of a magnetized core 402 can interfere with this current transfer and aid in preventing the formation of an arc. In some exemplary embodiments of the present invention more than one of the wires is magnetized. Further, in some embodiments, the core wire 402 is not magnetized but at least one of the outer wires 404a-f can be magnetized as described above. For example, in some embodiments—which do not have a core wire, but have a helically wrapped construction, at least one of the wires can be magnetized. For example, in some embodiments, ever other of the wires—in a rotational direction—can be magnetized.

In further exemplary embodiments, a non-conductive adhesive can be used to join at least some of the wires together to prevent the transfer of current between the wires. The adhesive should be of a type that is compatible with the desired weld deposit chemistry or of the type that is vaporized as the consumable is heated such that the adhesive is vaporized and not added to the weld deposit during welding.

It should be noted that while embodiments discussed above are related to hot-wire applications, embodiments of the present invention can be utilized in GMAW-type welding operations.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A hot-wire consumable, said consumable comprising:
a first consumable portion having an outer surface; and
a second consumable portion having an outer surface,
wherein said outer surface of said first consumable portion is secured to said outer surface of said second consumable portion to form said hot-wire consumable, and
wherein a maximum distance from said outer surface of said first consumable portion to said outer surface of said second consumable portion defines a diameter of a circumscribing circle around said hot-wire consumable.

2. The consumable of claim 1, wherein said diameter of said circumscribing circle is in a range from 0.030 inch to 0.250 inch.

3. The consumable of claim 1, wherein said securing is done via at least one of a bond between said first consumable portion and said second consumable portion and an arrangement of said first consumable portion and said second consumable portion.

4. The consumable of claim 3, wherein said securing is done via said bond, said bond being at least one of an adhesive, a mechanical bond formed by soldering, and a mechanical bond formed by brazing.

5. The consumable of claim 3, wherein material compositions of said first consumable portion, said second consumable portion, and said bond are same.

6. The consumable of claim 3, wherein a material composition of said bond is different from a material composition of at least one of said first consumable portion and said second consumable portion.

7. The consumable of claim 3, wherein a material composition of said bond vaporizes prior to reaching a melting temperature of said hot-wire consumable.

8. The consumable of claim 1, wherein a material composition of said first consumable portion is different than a material composition of said second consumable portion.

9. The consumable of claim 1, wherein said first consumable portion and said second consumable portion are braided or helically wrapped with each other.

10. A hot-wire consumable, said consumable comprising:
a first consumable portion having an outer surface; and
a second consumable portion having an outer surface,
wherein said first consumable portion has a center which is co-axial with a center of said hot-wire consumable said second consumable portion is secured to said outer surface of said first consumable portion to form said hot-wire consumable, and
wherein a maximum distance from said outer surface of said first consumable portion to said outer surface of said second consumable portion defines a diameter of a circumscribing circle around said hot-wire consumable.

11. The consumable of claim 10, wherein said diameter of said circumscribing circle is in a range from 0.030 inch to 0.250 inch.

12. The consumable of claim 10, wherein said securing is done via at least one of a bond between said first consumable portion and said second consumable portion and an arrangement of said first consumable portion and said second consumable portion.

13. The consumable of claim 12, wherein said securing is done via said bond, said bond being at least one of an adhesive, a mechanical bond formed by soldering, and a mechanical bond formed by brazing.

14. The consumable of claim 10, wherein said second consumable portion is coiled around said first consumable portion.

15. The consumable of claim 13, wherein material compositions of said first consumable portion, said second consumable portion, and said bond are same.

16. The consumable of claim 13, wherein a material composition of said bond is different from a material composition of at least one of said first consumable portion and said second consumable portion.

17. A hot-wire consumable, said consumable comprising:
a first consumable portion having an outer surface; and
a second consumable portion having an outer surface,
wherein said first consumable portion said second consumable portion are formed as an integral component to form said hot-wire consumable, and
wherein a maximum distance from said outer surface of said first consumable portion to said outer surface of said second consumable portion defines a diameter of a circumscribing circle around said hot-wire consumable, and
wherein said diameter of said circumscribing circle is in a range from 0.030 inch to 0.250 inch.

18. The consumable of claim 17, wherein a cross-sectional area of said first consumable portion is same as a cross-sectional area of said second consumable portion.

19. The consumable of claim 17, wherein a cross-sectional area of said first consumable portion is different than a cross-sectional area of said second consumable portion.

20. The consumable of claim 17, wherein said first consumable portion and said second consumable portion are braided or helically wrapped with each other.
